(19) United States
(12) Patent Application Publication
(10) Pub. No.: US 2017/0039660 A1
(43) Pub. Date: Feb. 9, 2017

(54) Autonomous Charging Station

(71) Applicant: AESP Green Energy Inc., Terrebonne, QC (CA)

(72) Inventors: Francis TOURIGNY, Terrebonne (CA); Edouard AUBÉ, Terrebonne (CA); Leo CLARKIN, Ottawa (CA)

(73) Assignee: AESP Green Energy Inc., Terrebonne, OC, QC (CA)

(21) Appl. No.: 15/304,636

(22) PCT Filed: Apr. 17, 2015
(86) PCT No.: PCT/CA2015/000255

§ 371 Date: Oct. 17, 2016

Related U.S. Application Data
(60) Provisional application No. 61/980,841, filed on Apr. 17, 2014.

(51) Int. Cl. G06Q 50/06; H01M 10/44; H02J 7/00; G06Q 20/06; H02J 7/35

(52) U.S. Cl. CPC G06Q 50/06; G06Q 20/06; H02J 7/35; H02J 7/0021; H01M 10/441; H02J 2007/0001; H01M 2220/30; H02J 2007/0096

(57) ABSTRACT

Method and charging station for charging rechargeable battery-operated device(s). The charging station comprises at least one receptacle for receiving at least one rechargeable battery-operated device to be charged, a payment module for processing a payment for allowing one or more of the at least one rechargeable battery-operated device to be charged for a period of time and a charging module for charging the one or more of the at least one rechargeable battery-operated device within the at least one receptacle, in accordance with the processed payment, the charging module receiving electrical power from a local power generator. The method comprises receiving the rechargeable battery-operated device for connection into the receptacle, processing a payment for allowing the rechargeable battery-operated device to be charged for a period of time and charging the rechargeable battery-operated device within the receptacle, in accordance with the processed payment.

### PRIORITY STATEMENT

This non-provisional patent application claims priority based upon the prior U.S. provisional patent applications entitled “AUTONOMOUS CHARGING STATION”, application No. 61/980,841, filed Apr. 17, 2014, in the names of Francis TOURIGNY Edouard AUBÉ and Leo CLARKIN, which is hereby incorporated by reference in its entirety.

### TECHNICAL FIELD

The present invention relates to a charging station and, more particularly, to an autonomous charging station.

### BACKGROUND

Certain areas of the world are poorly connected to the electrical grid. Getting electrical power for different day-to-day needs becomes difficult and dangerous. In some other regions, people seek to rely on alternate source of electrical power.

The present invention generally addresses the need for electric power.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A first aspect of the present invention is directed to a charging station comprising at least one receptacle for receiving at least one rechargeable battery-operated device to be charged, a payment module for processing a payment for allowing one or more of the at least one rechargeable battery-operated device to be charged for a period of time and a charging module for charging the one or more of the at least one rechargeable battery-operated device within the at least one receptacle, in accordance with the processed payment, the charging module receiving electrical power from a local power generator.

Optionally, the at least one rechargeable battery-operated device may comprise a power pack device and a portable electronic device.

The charging station may also comprise an account management module for managing at least one account. The payment may be used to replenish a balance of charging credits associated with the at least one account, each of the charging credits allowing the one or more of the at least one rechargeable battery-operated device to be charged for the period of time.

The charging station may further comprise an input/output module for allocating one or more of the charging credits to one or more of the at least one receptacle. The account management module may then further be for removing the allocated charging credits from the balance and activating the charging module for the one or more of the at least one receptacle.

The input/output module may also be for allowing authentication into the at least one account and the account management module may be further for, following the authentication, removing at least one allocated charging credit from the balance when a connection is established with the one or more of the at least one rechargeable battery-operated device within the at least one receptacle. The payment module may also be further for processing at least one rental payment for maintaining the at least one account on the charging station, wherein the at least one account being maintained is a requirement of the authentication.

The account management module may also further be for managing a plurality of secondary accounts associated with the at least one account, the charging station further comprising an input/output module for allocating one or more of the charging credits to one or more of the secondary accounts.

The period of time may end when one or more of the following conditions are met:
a timer expires;
a quantity of energy has been provided;
the battery-operated device is fully charged;
the battery-operated device is disconnected;
the battery-operated device is disconnected and a different battery-operated device is connected
a door of the at least one receptacle is opened;
the door of the at least one receptacle is unlocked; and
more than one battery-operated device is connected within a single of the at least one receptacle.

The charging station may further comprise a network interface module and the payment module may receive a confirmation of the processed payment through the network interface module.

The charging station may also comprise a station management module for remotely monitoring the charging station through the network interface module. The station management module allowing at least one of:
camera monitoring of the charging station and/or surroundings thereof;
accelerometer monitoring of the charging station; and
integrity monitoring of the charging station;
The station management module may be capable of sending network alerts, based on monitoring conditions, towards at least one of a law enforcement agency, a mobile operator, a charging station's owner, a registered charging station's user and/or a registered charging station's manager.

The confirmation of the payment may be received, through a cellular network, from:
a credit card issuer;
an online payment service provider;
a prepaid card issuer;
a mobile network operator; or
a interbank transfer service.

The local power generator may comprise a solar generator integrated with a housing of the charging station and/or the local power generator may comprise a wind generator collocated with a housing of the charging station. The local power generator may be autonomous by being disconnected from the distribution grid.

The input/output module may comprise a Graphical User Interface (GUI) operated through a touch sensitive surface. The GUI may be for presenting instructional information via graphical instructions with minimal textual instructions.

The charging station may further comprise a plurality of charging ports adapted for connecting the rechargeable battery operated device, within the at least one receptacle, to the charging module. The plurality of charging ports may comprise at least two of:
one or more Universal Serial Bus (USB) interfaces;
a 120/240 VAC on 50/60 Hz interface;
a proprietary power-pack charging interface; and
one or more Power of Ethernet (POE) interfaces.

The charging station may also further comprise at least one door to lock the at least one receptacle.

The charging module may further be for measuring a battery charge of the battery-operated device and/or for calculating a charge time of the battery-operated device.

The charging module may also further be for visually indicating when the battery has been charged.

The network interface module may further be for providing a public Wireless Local Area Network (WLAN) access towards a cellular network, wherein the payment module is further for processing one or more access payments for accessing the WLAN and/or Mobile Network Operator (MNO) network range extension functionality.

A second aspect of the present invention is directed to a method for charging a rechargeable battery-operated device comprising receiving the rechargeable battery-operated device for connection into a receptacle of a charging station, the charging station receiving electrical power from a local power generator, processing a payment for allowing the rechargeable battery-operated device to be charged for a period of time and charging the rechargeable battery-operated device within the receptacle, in accordance with the processed payment.

Optionally, the rechargeable battery-operated device may be a power pack device or a portable electronic device.

Processing the payment may further comprise replenishing a balance of charging credits associated with an account, each of the charging credits allowing the rechargeable battery-operated device to be charged for the period of time.

The method may further comprise, prior to charging, allocating one or more of the charging credits to the receptacle and removing the allocated charging credits from the balance, wherein charging is performed by activating a charging module for the receptacle.

The method may also further comprise authenticating into the account and, following the authentication, removing at least one allocated charging credit from the balance when a connection is established with the rechargeable battery-operated device within the receptacle.

The method may yet also further comprise processing at least one rental payment for maintaining the account on the charging station, wherein the account being maintained is a requirement of the authentication.

The method may also comprise managing a plurality of secondary accounts associated with the account and allocating one or more of the charging credits to one or more of the secondary accounts.

The period of time may end when one or more of the following conditions are met:
a timer expires;
a quantity of energy has been provided;
the battery-operated device is fully charged;
the battery-operated device is disconnected;
the battery-operated device is disconnected and a different battery-operated device is connected
a door of the at least one receptacle is opened;
the door of the at least one receptacle is unlocked; and
more than one battery-operated device is connected within a single of the at least one receptacle.

The method may also further comprise receiving a confirmation of the processed payment through a network interface module of the charging station, and, optionally, remotely monitoring the charging station through the network interface module by allowing at least one of:
camera monitoring of the charging station and/or surroundings thereof;
accelerometer monitoring of the charging station; and
integrity monitoring of the charging station;

The method may then further comprises sending network alerts, based on monitoring conditions, towards at least one of a law enforcement agency, a mobile operator, a charging station's owner, a registered charging station's user and/or a registered charging station's manager.

The confirmation may be received, through a cellular network, from:
a credit card issuer;
an online payment service provider;
a prepaid card issuer;
a mobile network operator; or
a interbank transfer service.

The local power generator may comprise a solar generator integrated with a housing of the charging station and/or a wind generator collocated with a housing of the charging station. The local power generator may be autonomous by being disconnected from the distribution grid.

A Graphical User Interface (GUI) operated through a touch sensitive surface may also be provided. The GUI may be for presenting instructional information via graphical instructions with minimal textual instructions.

The method may comprise providing a plurality of charging ports adapted for connecting the rechargeable battery operated device, within the receptacle. The plurality of charging ports may comprise at least two of:
one or more Universal Serial Bus (USB) interfaces;
a 120/240 VAC on 50/60 Hz interface; and
a proprietary power-pack charging interface; and
one or more Power of Ethernet (POE) interfaces.

The method may also further comprise providing at least one door to lock the receptacle, measuring a battery charge of the battery-operated device, calculating a charge time of the battery-operated device and/or visually indicating when the battery has been charged.

The method may further comprise providing a public Wireless Local Area Network (WLAN) access towards a cellular network and processing one or more access payments for accessing the WLAN and/or providing Mobile Network Operator (MNO) network range extension functionality.

### BRIEF DESCRIPTION OF THE DRAWINGS

Further features and exemplary advantages of the present invention will become apparent from the following detailed description, taken in conjunction with the appended drawings, in which:

FIG. 1 shows a logical modular representation of a system comprising an exemplary charging station in accordance with the teachings of the present invention; and

FIG. 2 shows a flow chart of an exemplary method for charging a rechargeable battery-operated device in accordance with the teachings of the present invention.

### DETAILED DESCRIPTION

It has been noticed that, in recent years and in many areas, the connection to the grid or to line-wired phones improved less rapidly than connectivity to a cellular network (voice and/or data). No indication suggests that the trend is temporary.

In the same areas, it has also been noticed that people take different risks to get electrical power. For instance, diesel or kerosene generators and/or lanterns are sometimes used inside the homes (e.g., for charging devices or for lighting purposes). It has also been noticed that many people would give their mobile phone to a messenger (or modern-age mailman) that would walk or drive over a certain distance to reach a grid-connected location where the phone is charged for a fee. People may then remain without a mobile phone for a long while and take the risk of having their phone lost or stolen.

If ever the distribution grid is available, connectivity and/or distribution may be difficult. In addition, energy from the grid may be produced from non-environmental friendly sources.

A secured autonomous charging station for portable devices and/or portable power sources would therefore be useful to overcome at least some of these drawbacks.

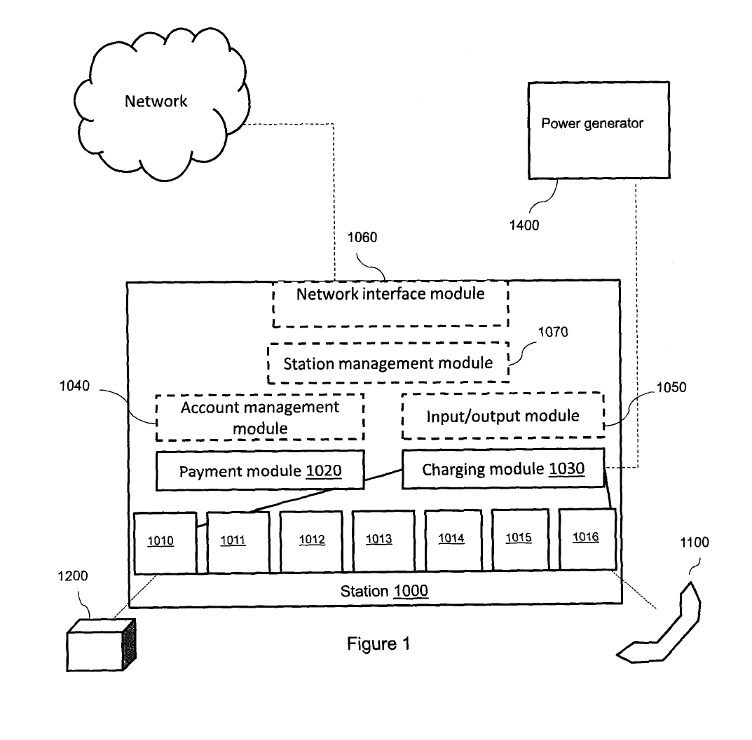

Reference is now made to the drawings in which FIG. 1 shows a modular logical representation of an exemplary charging station 1000 in accordance with the teachings of the present invention. The charging station 1000 comprises at least one receptacle (1010 to 1016), a payment module 1020 and a charging module 1030. The charging module receives electrical power from a local power generator 1400. For instance, the local power generator 1400 may comprise a solar generator integrated with a housing of the charging station and/or a wind generator collocated with the housing of the charging station. In the most commonly envisioned embodiments, the local power generator is autonomous by being disconnected from the distribution grid. In other embodiments, the charging station may be connected to the grid and use power therefrom only when strictly necessary (e.g., failure of the local power generator or failure of an accumulating device of the local power generator, failure to meet the energy demand, etc.).

Skilled persons will readily understand that the number of actual receptacles 1010-1016 may vary without affecting the present invention. Each receptacle 1010-1016 is for receiving at least one rechargeable battery-operated device to be charged. The rechargeable battery-operated device may be at least a power pack device 1200 or a portable electronic device 1100 (e.g. a mobile phone, a handheld music player, a portable GPS system, smart tablets, car batteries, etc.).

The payment module 1020 is for processing a payment for allowing one or more rechargeable battery-operated devices 1100, 1200 to be charged for a period of time. The charging module 1030 is for charging the rechargeable battery-operated device(s) 1100, 1200 within the relevant receptacle(s) 1010-1016, in accordance with the processed payment.

An account management module 1040 may be provided for managing at least one account. The payment maybe used to replenish a balance of charging credits associated with an account. Each of the charging credits may allow the rechargeable battery-operated device to be charged for the period of time. An input/output module 1050 may also be provided for allocating one or more of the charging credits to one or more receptacles 1010-1016. The account management module 1040 may then remove the allocated charging credits from the balance and activate the charging module 1030 for the relevant receptacles 1010-1016.

The optional input/output module 1050 may also be used for allowing authentication into the account. The account management module may then, following the authentication, remove at least one allocated charging credit from the balance when a connection is established with the rechargeable battery-operated device within the receptacle 1010-1016.

The input/output module 1050 may comprise a Graphical User Interface (GUI) operated through a touch sensitive surface (e.g., a resistive touch screen, surface acoustic wave touch screen, a capacitive sensing touch screen, an infrared touch screen, etc.). The GUI may be presenting instructional information via graphical instructions with minimal textual instructions. This may prove particularly useful in areas where many languages are expected to be commonly used and/or in areas where alphabetization is low.

The payment module 1020 may also further process at least one rental payment for maintaining the account on the charging station 1000. The account being properly maintained (e.g., by receiving periodic rental payments) may be a requirement of the authentication.

The account management module 1040 may also be used for managing a plurality of secondary accounts associated with the account. The input/output module 1050 may then be used for allocating one or more of the charging credits to one or more of the secondary accounts.

The period of time may be considered ended (e.g., charging stops) when one or more of the following conditions are met:
a timer expires;
a quantity of energy has been provided;
the battery-operated device is fully charged;
the battery-operated device is disconnected;
the battery-operated device is disconnected and a different battery-operated device is connected
a door of the at least one receptacle is opened;
the door of the at least one receptacle is unlocked; and
more than one battery-operated device is connected within a single of the at least one receptacle.

The charging station may also comprise a network interface module 1060. The payment module 1020 may receive a confirmation of the processed payment through the network interface module 1060. The confirmation may further be received, through a cellular network, from:
a credit card issuer;
an online payment service provider;
a prepaid card issuer;
a mobile network operator; or
a interbank transfer service.

A station management module 1070 may also be used for remotely monitoring the charging station through the network interface module 1060.

The station management module 1070 may be used for allowing at least one of:
camera monitoring of the charging station and/or surroundings thereof;
accelerometer monitoring of the charging station; and
integrity monitoring of the charging station;

The station management module 1070 may be able to send network alerts, based on monitoring conditions, towards at least one of a law enforcement agency, a mobile operator, a charging station's owner, a registered charging station's user and/or a registered charging station's manager.

A plurality of charging ports may be provided for connecting the rechargeable battery operated device, within the receptacles 1010-1016, to the charging module 1030. The charging ports may comprise one or more, and in a preferred embodiment at least two, of:
one or more Universal Serial Bus (USB) interfaces;
a 120/240 VAC on 50/60 Hz interface;
a proprietary power-pack charging interface; and
one or more Power of Ethernet (PoE) interfaces.

At least one door (not shown) may be provided to lock the receptacle(s) 1010-1016. For instance, a single door may be used to cover all receptacles 1010-1016 and/or individual door(s) may be provided over some or all of the individual receptacles. Locking/unlocking of the door(s) may be controlled from the input/output module 1050 (i.e. keyless) or may require one or more physical keys. Action of the door may be used to account charging credits usage and/or control charging of the device 1100, 1200.

The charging module 1030 may measure a battery charge of the battery-operated device 1100 and/or calculate a current charge or charge time of the battery-operated device 1100. The charging module 1030 may visually indicate when the battery has been charged (e.g., through the input/output device 1050 and/or one or more LEDs associated with the relevant receptacle(s) 1010-1016).

In some embodiments, the network interface module 1060 may further provide a public Wireless Local Area Network (WLAN) access towards a cellular network. The payment module 1020 may then also process one or more access payments for accessing the WLAN. The network interface module may further provide a Mobile Network Operator (MNO) network range extension functionality.

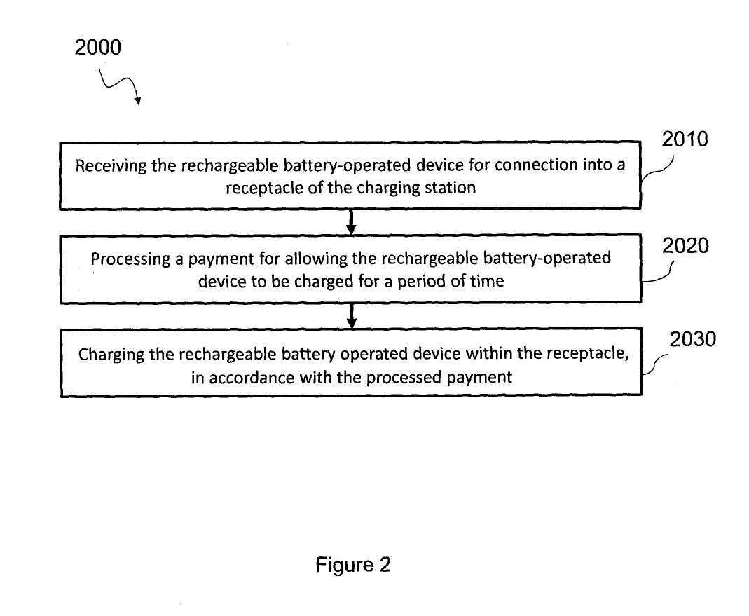

FIG. 2 shows a flow chart of an exemplary method 2000 for charging a rechargeable battery-operated device 1100, in the charging station 1000 receiving electrical power from the local power generator 1040, in accordance with the teachings of the present invention. The method 2000 comprises receiving 2010 the rechargeable battery-operated device 1100 for connection into a receptacle 1010 of the charging station 1000, processing 2020 a payment for allowing the rechargeable battery-operated device 1100 to be charged for a period of time and charging 2030 the rechargeable battery-operated device 1100 within the receptacle, in accordance with the processed payment.

Processing the payment 2020 may further comprise replenishing a balance of charging credits associated with an account, each of the charging credits allowing the rechargeable battery-operated device to be charged for the period of time.

Prior to charging 2030, the method 2000 may comprise allocating one or more of the charging credits to the receptacle 1010 and removing the allocated charging credits from the balance. Charging 2030 is then performed by activating a charging module for the receptacle 1010.

The method 2000 may also comprise authenticating into the account and, following the authentication, removing at least one allocated charging credit from the balance when a connection is established with the rechargeable battery-operated device 1100 within the receptacle 1010.

The method 2000 may also comprise processing at least one rental payment for maintaining the account on the charging station. The account being maintained may be a requirement of the authentication.

The method 2000 may also comprise managing a plurality of secondary accounts associated with the account and allocating one or more of the charging credits to one or more of the secondary accounts.

The method 2000 may also comprise receiving a confirmation of the processed payment through the network interface module 1060 of the charging station 1000.

The method 2000 may also comprise remotely monitoring the charging station 1100 through the network interface module 1100 by allowing at least one of:
camera monitoring of the charging station and/or surroundings thereof;
accelerometer monitoring of the charging station; and
integrity monitoring of the charging station;
wherein the method further comprises sending network alerts, based on monitoring conditions, towards at least one of a law enforcement agency, a mobile operator, a charging station's owner, a registered charging station's user and/or a registered charging station's manager.

The method 2000 may also comprise measuring a battery charge of the battery-operated device 1100, and/or calculating a charge time or charge of the battery-operated device 1100. The method 2000 may also comprise visually indicating when the battery has been charged.

Skilled person will readily understand that the exemplary method 2000 could also be provided for different devices in different receptacles without affecting the invention.

Even though explicit mentions of memory module and/or the processor module are not made throughout the description of the present examples, persons skilled in the art will readily recognize that such modules may be used in conjunction with other modules of the charging station 1000 to perform routine as well as innovative steps related to the present invention. The processor module may represent a single processor with one or more processor cores or an array of processors, each comprising one or more processor cores. The memory module may comprise various types of memory (different standardized or kinds of Random Access Memory (RAM) modules, memory cards, Read-Only Memory (ROM) modules, programmable ROM, etc.). A storage devices module may be present as one or more logical or physical as well as local or remote hard disk drive (HDD) (or an array thereof) or any other storage technology. The storage devices module may further represent a local or remote database made accessible by a standardized or proprietary interface. The network interface module 1060 represents at least one physical interface that can be used to communicate with other network nodes. The network interface module 1060 may be made visible to the other modules of the charging station 1000 through one or more logical interfaces. The actual stacks of protocols used by the physical network interface(s) and/or logical network interface(s) of the network interface module 1060 do not affect the teachings of the present invention. The variants of processor module, memory module, network interface module and storage devices module usable in the context of the present invention will be readily apparent to persons skilled in the art.

Various network links may be implicitly or explicitly used in the context of the present invention. While a link may be depicted as a wireless link, it could also be embodied as a wired link using a coaxial cable, an optical fiber, a category 5 cable, and the like. A wired or wireless access point (not shown) may be present on the link between. Likewise, any number of routers (not shown) may be present and part of the link, which may further pass through the Internet.

The present invention is not affected by the way the different modules exchange information between them. For instance, the memory module and the processor module could be connected by a parallel bus, but could also be connected by a serial connection or involve an intermediate module (not shown) without affecting the teachings of the present invention.

A method is generally conceived to be a self-consistent sequence of steps leading to a desired result. These steps require physical manipulations of physical quantities. Usually, though not necessarily, these quantities take the form of electrical or magnetic/electromagnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities. The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A charging station comprising:
at least one receptacle for receiving one or more of a plurality of rechargeable power pack devices rechargeable at the charging station, each of the power pack devices being a portable power source usable in a home;
a payment module for processing a payment for allowing one of the plurality of power pack devices to be charged for a period of time in one of the at least one receptacle; and
a charging module for charging the one or more of the power pack device within the one receptacle, in accordance with the processed payment, the charging module receiving electrical power from a local solar power generator.

2. The charging station of claim 1, wherein the at least one receptacle is further for receiving at least one portable electronic device.

3. The charging station of claim 1 further comprising an account management module for managing at least one account, wherein the payment replenishes a balance of charging credits associated with the at least one account, each of the charging credits allowing the one or more of the at least one rechargeable battery-operated device to be charged for the period of time.

4. The charging station of claim 3 further comprising an input/output module for allocating one or more of the charging credits to one or more of the at least one receptacle, the account management module being further for removing the allocated charging credits from the balance and activating the charging module for the one or more of the at least one receptacle.

5. The charging station of claim 3 further comprising an input/output module for allowing authentication into the at least one account and the account management module being further for, following the authentication, removing at least one allocated charging credit from the balance when a connection is established with the one or more of the at least one rechargeable battery-operated device within the at least one receptacle.

6. The charging station of claim 5, wherein the payment module is further for processing at least one rental payment for maintaining the at least one account on the charging station, wherein the at least one account being maintained is a requirement of the authentication.

7. The charging station of claim 3, wherein the account management module is further for managing a plurality of secondary accounts associated with the at least one account, the charging station further comprising an input/output module for allocating one or more of the charging credits to one or more of the secondary accounts.

8. The charging station of claim 1, wherein the period of time ends when one or more of the following conditions are met:
a timer expires;
a quantity of energy has been provided;
the battery-operated device is fully charged;
the battery-operated device is disconnected;
the battery-operated device is disconnected and a different battery-operated device is connected
a door of the at least one receptacle is opened;
the door of the at least one receptacle is unlocked; and
more than one battery-operated device is connected within a single of the at least one receptacle.

9. (canceled)

10. The charging station of claim 1 further comprising a network interface module and a station management module for remotely monitoring the charging station through the network interface module, the station management module allowing at least one of:
camera monitoring of the charging station and/or surroundings thereof;
accelerometer monitoring of the charging station; and
integrity monitoring of the charging station;
wherein the station management module is capable of sending network alerts, based on monitoring conditions, towards at least one of a law enforcement agency, a mobile operator, a charging station's owner, a registered charging station's user and/or a registered charging station's manager.

11. The charging station of claim 9 further comprising a network interface module, wherein the confirmation is received, through a cellular network, from:
a credit card issuer;
an online payment service provider;
a prepaid card issuer;
a mobile network operator; or
a interbank transfer service.

12. The charging station of claim 1, wherein the local solar power generator is integrated with a housing of the charging station.

13. The charging station of claim 1, wherein the local power generator further comprises a wind generator collocated with a housing of the charging station.

14. The charging station of claim 1, wherein the local power generator is autonomous by being disconnected from the distribution grid.

15. (canceled)

16. The charging station of claim 1 further comprising an input/output module comprising a Graphical User Interface (GUI) operated through a touch sensitive surface, the GUI presenting instructional information via graphical instructions with minimal textual instructions.

17. (canceled)

18. The charging station of claim 1, further comprising a plurality of charging ports adapted for connecting the rechargeable power pack, wherein the plurality of charging ports comprise at least two of:
one or more Universal Serial Bus (USB) interfaces;
a 120/240 VAC on 50/60 Hz interface;
a proprietary power-pack charging interface; and
one or more Power of Ethernet (POE) interfaces.

19.-21. (canceled)

22. The charging station of claim 1 further comprising an input/output module, upon completion of the charge by the charging module, for visually indicating when the one or more of the plurality of power pack devices has been charged.

23.-24. (canceled)

25. A method for charging a plurality of rechargeable power pack devices comprising:
receiving one or more of the plurality of rechargeable power pack devices for connection into at least one receptacle of a charging station, each of the power pack devices being a portable power source usable in a home and the charging station receiving electrical power from a local solar power generator;
processing a payment for allowing one of the rechargeable power pack device to be charged for a period of time; and
charging the rechargeable power pack device within the at least one receptacle, in accordance with the processed payment.

26. The method of claim 25 further comprising receiving a portable electronic device for connection into the at least one receptacle of the charging station, processing a second payment for allowing the portable electronic device to be charged for a second period of time and charging the portable electronic device within the at least one receptacle, in accordance with the second processed payment.

27.-48. (canceled)

49. The charging station of claim 1, wherein the charging module activates the charging of the one power pack device upon authentication thereof via an account management module following establishment of a connection with the one power pack device.

50. The charging station of claim 2, wherein the connection is established through a charging port of the charging station over a proprietary power-pack charging interface.

51. The charging station of claim 3, further comprising an input/output module comprising a Graphical User Interface (GUI) for allocating one or more charging credits to the one receptacle, the GUI presenting instructional information via graphical instructions with minimal textual instructions.

52. The charging station of claim 1, further comprising a network interface module is for providing a public Wireless Local Area Network (WLAN) access towards a cellular network, wherein the payment module is further for processing one or more access payments for accessing the WLAN.

53. The method of claim 25 further comprising activating charging of the one power pack device upon authentication thereof via an account management module following establishment of the connection with the one power pack device.

54. The method of claim 53, wherein the connection is established through a charging port of the charging station over a proprietary power-pack charging interface.

55. The method of claim 54, further comprising providing an input/output module comprising a Graphical User Interface (GUI) at the charging station for allocating one or more charging credits to the one receptacle, the GUI presenting instructional information via graphical instructions with minimal textual instructions.

56. The method of claim 25 further comprising providing a public Wireless Local Area Network (WLAN) access, via a network interface module of the charging station, towards a cellular network and processing one or more access payments for accessing the WLAN.
